(19) United States
(12) Patent Application Publication
(10) Pub. No.: US 2007/0105437 A1
(43) Pub. Date: May 10, 2007

(54) Coaxial cable

(76) Inventors: Shogo Imamura, Ibaraki (JP); Yoshio Kamimura, Tokyo (JP)

Correspondence Address: COLLEN IP, THE HOLYOKE MANHATTAN BUILDING, 80 SOUTH HIGHLAND AVENUE, OSSINING, NY, 10562, US

(21) Appl. No.: 10/580,887

(22) PCT Filed: Nov. 24, 2004
(86) PCT No.: PCT/JP04/17820

§ 371 Date: Nov. 8, 2006

(30) Foreign Application Priority Data
Nov. 25, 2003 (JP) 2003393991

(51) Int. Cl. H01R 9/05

(52) U.S. Cl. 439/578

(57) ABSTRACT

A coaxial cable comprises: a dielectric layer formed around a center conductor; an outer conductor layer formed around the dielectric layer; and a sheath formed around the outer conductor layer. A metal foil for providing enhanced shield effect and shape maintainability is formed between the dielectric layer and the outer conductor layer. The coaxial cable is enabled to have a high shielding effect on the signal leakage or the like, which might otherwise augment the quantity of attenuation. The coaxial cable can keep the electric characteristics excellent for a high-frequency signal. The coaxial cable can be easily and freely bent by hand without any use of tools. The coaxial cable is excellent, after bent, in the shape maintainability in the bent shape state. Because of this excellent shape maintainability, the coaxial cable can facilitate wiring work or connecting work.

### TECHNICAL FIELD

The present invention relates to a coaxial cable for transmitting a high-frequency signal and, more particularly, to a coaxial cable having a flexibility and having an excellent shape maintainability for keeping the shape of a bent state excellent in case that the coaxial cable is bent.

### BACKGROUND ART

In the prior art, a coaxial cable is used for transmitting a high-frequency signal such as a microwave band and in a base station necessary for communications of mobile telephones, or for the in-device wiring of a measurement device. This coaxial cable is required to have the high-frequency characteristics of not only a stable impedance and a low attenuation but also of an excellent shielding effect against noises or the like.

As the coaxial cable having such excellent shielding effect, there has been commercially available and frequently used a semi-rigid type coaxial cable, which is formed by disposing a dielectric member around a center conductor and by disposing a copper pipe as an outer conductor around the dielectric member. Where this semi-rigid type coaxial cable has to be bent when it is wired and assembled or when it is connected with a device terminal or the like at a predetermined position, since a copper pipe is used as the outer conductor, the coaxial cable after bent has an excellent shape maintainability and facilitates the wiring work or the connecting work where such work is needed. However, there arises a problem that a special device such as a tool is needed for the bending work.

In JP-A-6-267342, for example, there has been proposed a semi-flexible type coaxial cable as a coaxial cable that has an excellent shielding effect and a certain degree of flexibility. This coaxial cable is manufactured by forming a dielectric member around a center conductor, forming a metal foil as a flexible shield around the dielectric member, and impregnating a braid formed around the metal foil, with a molten metal such as molten tin or solder.

This semi-flexible coaxial cable is provided with the semi-flexible properties by limiting the movement of an insulator relative to the shield by the metal foil and by bonding the metal foil and the braiding with the molten metal. In case the semi-flexible coaxial cable has to be bent, it is easily wired or connected at the position, because it has a rather higher flexibility than the semi-rigid coaxial cable and is excellent in the shape maintainability after bent. However, the semi-flexible coaxial cable has a problem that it is made too rigid for the easy and free bending work by hand, because of the bond between the metal foil and the braiding with the molten metal.

As the flexible coaxial cable, there is also a flexible coaxial cable commercially available and frequently used, which is manufactured by sequential operations to form a dielectric member around a center conductor and a braided or served outer conductor around the dielectric member, and to form a sheath around the outer conductor. This coaxial cable can be easily and freely bent by hand, if necessary, as described above. Because of the spring properties owned together with the flexibility by the coaxial cable, the coaxial cable will restore its original shape state even after being bent. This raises a problem that the shape maintainability to keep the bent shape is poor. In this coaxial cable, moreover, the outer conductor is braided or served so that the coaxial cable does not have a sufficient shielding effect against the high-frequency signal of the microwave band or the like.

### DISCLOSURE OF THE INVENTION

Therefore, the present invention has been conceived in view of the aforementioned problems, and has an object to provide a high-frequency coaxial cable, which has a high shielding effect on the signal leakage or the like, as might otherwise augment the quantity of attenuation, which can keep the electric characteristics excellent for a high-frequency signal, which can be easily and freely bent by hand without any use of tools, which is excellent, after bent, in the shape maintainability in the bent shape state, and which enables to facilitate the wiring work or the connecting work by that excellent shape maintainability.

The aforementioned object is achieved by a coaxial cable according to the invention. In short, according to the invention, there is provided a coaxial cable comprising: a dielectric layer formed around a center conductor; an outer conductor layer formed around the dielectric layer; and a sheath formed around the outer conductor layer. The coaxial cable is characterized in that a metal foil for applying enhanced shield effect and shape maintainability is formed between the dielectric layer and the outer conductor layer. Moreover, the coaxial cable is characterized in that the metal foil has a thickness of 1% to 5% of the outer diameter of the dielectric layer. Moreover, the coaxial cable is characterized in that the metal foil is longitudinally arranged around the dielectric layer between the dielectric layer and the outer conductor layer. Moreover, the coaxial cable is characterized in that the outer conductor layer is braided.

According to the invention, there is provided a coaxial cable comprising: a dielectric layer formed around a center conductor; an outer conductor layer formed around the dielectric layer; and a sheath formed around the outer conductor layer. The coaxial cable is characterized in that the metal foil for providing enhanced shield effect and shape maintainability is formed between the dielectric layer and the outer conductor layer. Therefore, the coaxial cable can have a high shielding effect against the signal leakage or the like, as might otherwise augment the quantity of attenuation, keep the electric characteristics excellent for a high-frequency signal, and overcome the shape maintaining members such as the dielectric layer and the sheath by the center conductor and the metal foil giving the shape maintainability, so that the coaxial cable can be easily and freely bent by hand without any use of tools while maintaining the shape after bent satisfactorily. As a result, because of the excellent shape maintainability of the coaxial cable, the coaxial cable does not restore its original shape after the bending work, unlike the coaxial cable of the prior art having the spring properties, but can facilitate the wiring work or the connecting work at a desired position, thereby reducing the labors in the wiring work or the connecting work.

### BRIEF DESCRIPTION OF THE DRAWINGS

FIG. 1 is a schematic perspective view of a preferred mode of embodiment of a coaxial cable according to the invention.

FIG. 2 is an explanatory view of a measuring method for measuring the shape maintainability of a bending work of the coaxial cable shown in FIG. 1.

FIG. 3 is an explanatory view of a measuring method for measuring the shape maintainability, after the bending work, of the coaxial cable shown in FIG. 1.

### BEST MODE FOR CARRYING OUT THE INVENTION

The coaxial cable according to the invention will be described on a preferred mode of embodiment with reference to the accompanying drawings.

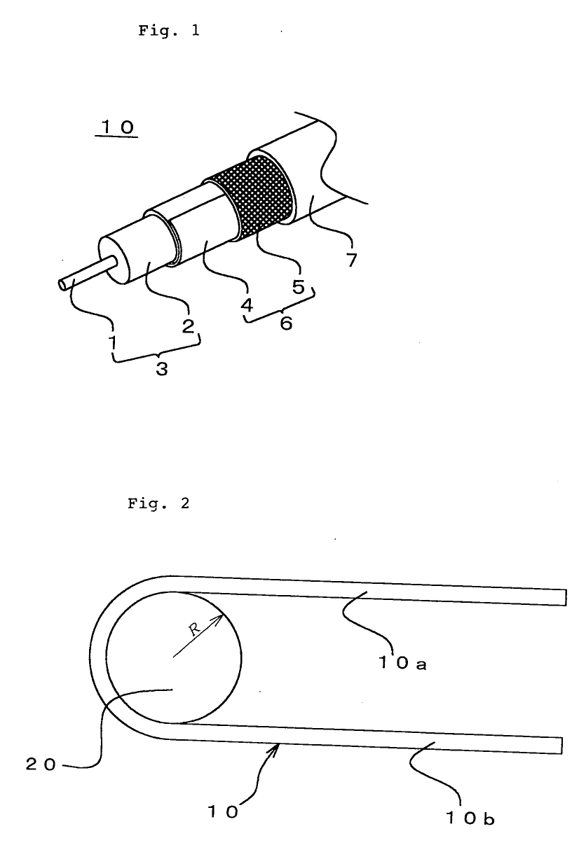

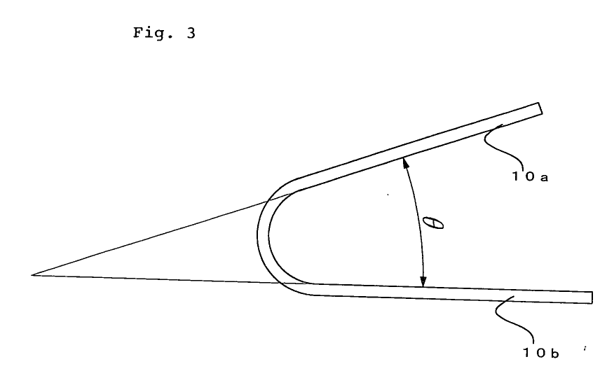

FIG. 1 is a schematic perspective view of a preferred mode of embodiment of a coaxial cable according to the invention; FIG. 2 is an explanatory view of a measuring method for measuring the shape maintainability of a bending work of the coaxial cable shown in FIG. 1; and FIG. 3 is an explanatory view of a measuring method for measuring the shape maintainability, after the bending work, of the coaxial cable shown in FIG. 1. It should be noted that the drawings are used exclusively for explaining the preferred mode of embodiment of the invention so that no consideration is taken into the scales of the individual portions.

With reference to FIG. 1, there is shown a coaxial cable 10 according to the invention. In this coaxial cable 10, for example, a center conductor 1 made of a single wire or a stranded wire of a silver-plated soft copper wire or a silver-plated copper-coated steel wire is coated by an extrusion molding method with a dielectric layer 2, which is made of a fluoropolymer of a low specific dielectric constant such as polytetrafluofoethylene (PTFE), tetrafluoroethylene-perfluoroalkylvinylether copolymer (PFA) or tetrafluoroethylene-hexafluoropropylene copolymer (FEP), or a proper resin such as polyethylene, thereby to form a core 3. By using the aforementioned resin, the dielectric layer 2 is not limited to a solid member but may also be foamed or extended around the center conductor 1 from the viewpoint of further decrease of specific dielectric constant or the shape keeping property.

In order to enhance the shielding effect of the coaxial cable 10 and to give a shape maintainability, the core 3 is provided, along the longitudinal direction of the core 3 in a longitudinally accompanying shape (i.e., a cigarette wrap fashion), with a metal foil 4, which is made of a copper foil or an aluminum foil having a thickness of 1% to 5%, more preferably 1% to 3% of the outer diameter of the dielectric layer 2. In the cigarette wrap fashion, the metal foil 4 is wound in overlapped manner to cover the outer circumference of the dielectric layer 2 or the core 3 sufficiently so that the width has a length about 1.1 to 1.9 times as large as the outer circumference of the dielectric layer 2, for example.

Here is explained the reason why the thickness of the metal foil 4 is set within the range of 1% to 5% of the outer diameter of the dielectric layer 2, i.e., the core diameter. If the thickness of the metal foil 4 is 1% or less of the outer diameter of the dielectric layer 2, the shape maintainability of the coaxial cable 10 is not sufficient so that no big difference in the shape maintainability from the flexible coaxial cable of the prior art having the spring properties can be obtained. If the thickness exceeds 5%, on the other hand, the coaxial cable 10 becomes excessively rigid so that it cannot be easily and freely bent by hand. Therefore, no advantage can be recognized over the semi-flexible coaxial cable of the prior art.

Around the metal foil 4, a braided layer or a served layer, which is made of a conductive element such as a silver-plated copper wire or a silver-plated copper-coated steel wire, is formed as the outer conductor layer 5. These metal foil 4 and outer conductor layer 5 form together the conductor layer 6 as a shielding layer. The outer conductor layer 5 gives a more shielding effect, in addition to the shielding effect of the metal foil 4, to the coaxial cable 10, and performs a function to hold the cigarette wrapping of the metal foil 4 reliably without any dispersion.

The conductor layer 6 is coated therearound by an extrusion molding method with a-sheath 7 made of polyvinyl chloride, polyethylene or the aforementioned fluoropolymer. This sheath 7 is preferably made of a soft resin having a flexibility.

The coaxial cable 10 thus prepared to have the dielectric member of the low specific dielectric constant has a flexibility in its entirety. This coaxial cable 10 is suitably used for a high-frequency purpose, for example, with an impedance of 50 ohms and for a service frequency band of 1 Giga Heltz (GHz) to 26.5 Giga Heltz (GHz). The coaxial cable 10 can have a high shielding effect on the signal leakage or the like, which might otherwise increase the quantity of attenuation, by the metal foil 4 and the outer conductor layer 5, which give the enhanced shielding effect. The coaxial cable 10 can keep the electric characteristics excellent for a high-frequency signal. Moreover, the coaxial cable 10 is provided with the shape maintainability by the metal foil 4 so that it can be easily and freely bent by hand without any use of tools, unlike the semi-flexible coaxial cable. As a result, the coaxial cable 10 can keep its shape state after being bent. Because of the excellent shape maintainability, therefore, the coaxial cable does not restore its original shape even after the bending work unlike the coaxial cable of the prior art having the spring properties, but can facilitate the wiring work or the connecting work at a desired position, thereby reducing the labors in the wiring work or the connecting work.

The invention will be described in connection with its Example and Comparison.

### EXAMPLE 1

A center conductor 1 made of a single wire of a silver-plated copper-coated steel wire or the like to have a diameter of 0.51 mm was coated therearound by the extrusion molding method with a dielectric layer 2 of PTFE thereby to form a core 3 having a diameter of 1.6 mm. This core 3 was wound in overlapped manner, around its outer circumference by the cigarette wrap fashion along its longitudinal direction, with a copper foil 4 having a thickness of 0.035 mm and a width of 8 mm. An outer conductor layer 5 was formed around the copper foil 4 by braiding soft copper wires each having a diameter of 0.08 mm with 5 ends and 16 picks. This outer conductor layer 5 was coated therearound by the extrusion molding method with a sheath 7 of polyvinyl chloride having a sheath thickness of 0.4 mm thereby to manufacture a coaxial cable 10 with an impedance of 50 ohms and for a service frequency of 26.5 GHz. The shape maintainability of the coaxial cable 10 was examined by the method shown in FIG. 2 and FIG. 3.

Specifically, the coaxial cable 10 of the invention was wound on a mandrel 20 having a radius (R) of 18 mm, and force was applied to the both ends of an upper and a lower coaxial cables 10a and 10b with respect to the mandrel 20 to bent to 180 degrees so that they became generally parallel to each other as shown in FIG. 2. After this bending operation, the coaxial cables 10a and 10b were set free at their two ends, respectively, as shown in FIG. 3, and the angle θ made between the lower coaxial cable 10b and the upper coaxial cable 10a was measured. This measurement has revealed that the angle θ of the coaxial cable 10 of the invention was about 15 degrees, which value has been accepted as excellent in the shape maintainability.

As Comparison 1, a semi-flexible coaxial cable excellent in the shape maintainability was manufactured. This semi-flexible coaxial cable was manufactured by coating a center conductor made of a single wire of a silver-plated copper-coated steel wire or the like having a diameter of 0.51 mm by the extrusion molding method with the PTFE as a dielectric material thereby to form a core having a diameter of 1.6 mm, by forming a braided layer of soft copper wires around the core to have an outer diameter of 2.1 mm, by impregnating the braided layer with tin to form an outer conductor, and by coating the outer conductor therearound by an extrusion molding method with polyvinyl chloride to a coating thickness of 0.4 mm, thereby to manufacture a semi-flexible coaxial cable with an impedeance of 50 ohms and for a service frequency of 26.5 GHz. This coaxial cable was measured on its shape maintainability by the same method like as described above. As a result, the angle θ of the semi-flexible coaxial cable of Comparison 1 was about 15 degrees, as accepted to be satisfactory for the shape maintainability like that of the coaxial cable of the invention. However, the coaxial cable of Comparison 1 was so rigid when it is bent, that it was difficult to bend by hand.

Here, the measurements of the shielding effect were performed on the coaxial cable of the invention and the coaxial cable of Comparison 1 by using a network analyzer (made by Anritsu Co., Ltd.). No prominent difference was recognized between the two.

### INDUSTRIAL APPLICABILITY

The coaxial cable of the invention transmits a signal of high frequency such as a microwave band. The coaxial cable has a flexibility and an excellent shape maintainability which when bent, can keep its bent shape satisfactorily. Therefore, the coaxial cable can be suitably used for coaxial cables in a base station necessary for the communications of mobile telephones or in the in-device wiring such as a measuring device.

1. A coaxial cable comprising: a dielectric layer formed around a center conductor; an outer conductor layer formed around the dielectric layer; and a sheath formed around the outer conductor layer,
characterized in that a metal foil for providing enhanced shield effect and shape maintainability is formed between said dielectric layer and said outer conductor layer.

2. A coaxial cable as set forth in claim 1,
characterized in that said metal foil has a thickness of 1% to 5% of the outer diameter of said dielectric layer.

3. A coaxial cable as set forth in claim 1,
characterized in that said metal foil is longitudinally arranged around said dielectric layer between said dielectric layer and said outer conductor layer.

4. A coaxial cable as set forth in claim 1,
characterized in that said outer conductor layer is braided.
